(19) United States
(12) Patent Application Publication
(10) Pub. No.: US 2017/0061677 A1
(43) Pub. Date: Mar. 2, 2017

(54) DISPARATE SCALING BASED IMAGE PROCESSING DEVICE, METHOD OF IMAGE PROCESSING, AND ELECTRONIC SYSTEM INCLUDING THE SAME

(71) Applicant: Samsung Electronics Co., Ltd., Suwon-si (KR)

(72) Inventor: Se-Un RYU, Seongnam-si (KR)

(21) Appl. No.: 15/150,366

(22) Filed: May 9, 2016

(30) Foreign Application Priority Data
Aug. 25, 2015 (KR) 10-2015-0119322

(51) Int. Cl. G06T 15/20; G06T 11/00; G06T 3/40

(52) U.S. Cl. CPC G06T 15/205; G06T 3/40; G06T 11/001; G06T 2207/10024; G06T 2207/20221

(57) ABSTRACT

An image processing device that includes an image segmenter, a scaler, and a blender. The image segmenter generates a first two-dimensional (2D) image and a second 2D image by dividing an input image based on color information of the input image and depth information of the input image. The scaler generates a first conversion image by resizing the first 2D image based on a first scaling value and a second conversion image by resizing the second 2D image based on a second scaling value different from the first scaling value. The blender generates an output image by combining the first conversion image with the second conversion image. The output image exhibits a three-dimensional (3D) perspective effect because of disparate scaling of the first and the second 2D images.

### CROSS-REFERENCE TO RELATED APPLICATION

This application claims priority under 35 USC §119 to Korean Patent Application No. 10-2015-0119322 filed on Aug. 25, 2015 in the Korean Intellectual Property Office (KIPO), the contents of which are herein incorporated by reference in their entirety.

### TECHNICAL FIELD

The present disclosure generally relates to image processing. More particularly, and not by way of limitation, exemplary embodiments of the inventive aspect disclosed in the present disclosure are directed to image processing using disparate scaling of different two-dimensional (2D) portions of an image to provide a three-dimensional (3D) perspective effect, and to image processing devices implementing such image processing and electronic systems including such image processing devices.

### BACKGROUND

Image recording devices have been adopted in various electronic systems and mobile systems such as, for example, computers, mobile phones, tablets, Virtual Reality (VR) equipments, and robotic systems. Recently, research has focused on an image recording device that can obtain distance information of an object as well as image information of the object. The image that is recorded by the image recording device can be processed in various ways. For example, a recorded image can be processed to represent a three-dimensional (3D) perspective effect. Researchers are conducting various research projects on techniques of representing the 3D perspective effect in a recorded image.

### SUMMARY

In a conventional technique of performing a zoom-in or a zoom-out on an image, the entire image is scaled with the same ratio. Thus, it is difficult to represent the 3D perspective effect for the image. In addition, a 3D coordinate calculation—where a 2D image is mapped into a 3D image—may be performed for the 3D perspective effect. However, this approach needs a large amount of calculation. Hence, it is difficult to represent the 3D perspective effect in real time when 3D coordinate calculations are involved.

Therefore, it is desirable to substantially obviate one or more of the above-mentioned problems resulting from the limitations and disadvantages of the related art. Consequently, it is desirable to provide an image processing device that is capble to efficiently represent a 3D perspective effect with relatively small calculation and processing cost.

In the image processing device according to particular embodiments of the present disclosure, a scaling operation for generating a scaled output image may be performed on portions of the input image with different, portion-specific scaling ratios. For example, in case of an input image containing an image of an object and an image of a background, the scaling operation may be performed on the first partial (2D) image of the object using a first ratio and on the second partial (2D) image of the background using a second ratio that is different from the first ratio. In case of a zoom-in operation, for example, the second ratio may be smaller than the first ratio. The scaled output image may be generated by combining the scaled partial images with each other so as to have a 3D perspective effect in the scaled output image. In other words, the image processing device may generate the scaled output image based on only a 2D image processing—for example, the 2D scaling operation—without a 3D coordinate calculation. Thus, the 3D perspective effect may be represented in real time with a relatively small calculation/workload and, hence, at a low cost of processing resource.

At least one exemplary embodiment of the present disclosure provides an electronic system including the above-mentioned image processing device.

An image processing device according to particular exemplary embodiments comprises an image segmenter, a scaler, and a blender. The image segmenter is configured to generate a first 2D image and a second 2D image by dividing an input image based on color information of the input image and depth information of the input image. The scaler is configured to generate a first conversion image by resizing the first 2D image based on a first scaling value and a second conversion image by resizing the second 2D image based on a second scaling value different from the first scaling value. The blender is configured to generate an output image having a 3D perspective effect by combining the first conversion image with the second conversion image.

In an exemplary embodiment, the first conversion image may be a magnified image of the first 2D image, and the second conversion image may be a magnified image of the second 2D image. Furthermore, the first scaling value may be greater than the second scaling value.

In another exemplary embodiment, the first 2D image may be associated with a first object in the input image, and the second 2D image may be associated with a second object in the input image different from the first object.

In an exemplary embodiment, the output image may be generated by superimposing the first conversion image onto the second conversion image.

In one embodiment, the image segmenter may be configured to further generate a third 2D image by dividing the input image based on the color information of the input image and the depth information of the input image. The scaler also may be configured to further generate a third conversion image by resizing the third 2D image. This resizing may be based on one of the following: the first scaling value, the second scaling value, or a third scaling value different from the first and second scaling values. Furthermore, the blender may be configured to generate the output image by combining the first, the second, and the third conversion images with one another.

In particular embodiments, the scaler may include a first scaling unit and a second scaling unit. The first scaling unit may be configured to generate first conversion image data corresponding to the first conversion image and first image data corresponding to the first 2D image. In one embodiment, the first conversion image data may be based on the first scaling value. The second scaling unit may be configured to generate second conversion image data corresponding to the second conversion image and second image data corresponding to the second 2D image. In one embodiment, the second conversion image data may be based on the second scaling value.

In an exemplary embodiment, the scaler may further include a storage unit. The storage unit may be configured to store the first conversion image data and the second conversion image data.

In certain exemplary embodiments, the image segmenter may include a color segmentation unit and a clustering unit. The color segmentation unit may be configured to generate a plurality of color data by performing a color classification on the input image based on the color information of the input image. The clustering unit may be configured to generate first image data corresponding to the first 2D image and second image data corresponding to the second 2D image based on the plurality of color data and the depth information of the input image.

In one embodiment, the clustering unit may be configured to further determine the first scaling value and the second scaling value based on the depth information of the input image.

In an exemplary embodiment, the image processing device may further include a scaling value generator. The scaling value generator may be configured to determine the first scaling value and the second scaling value based at least on the depth information of the input image. For example, in certain embodiments, the scaling value generator may determine the first scaling value and the second scaling value based on the depth information of the input image as well as a user setting signal.

In particular embodiments, the image processing device may further include an image pickup module. The image pickup module may be configured to obtain the color information of the input image and the depth information of the input image.

In an exemplary embodiment, the image processing device may further include an image pickup module and a depth measurement module. The image pickup module may be configured to obtain the color information of the input image, whereas the depth measurement module may be configured to obtain the depth information of the input image.

In particular embodiments, the present disclosure contemplate a method of image processing. The method comprises: (i) generating a first 2D image and a second 2D image by dividing an input image based on color information of the input image and depth information of the input image; (ii) generating a first conversion image by resizing the first 2D image based on a first scaling value; (iii) generating a second conversion image by resizing the second 2D image based on a second scaling value different from the first scaling value; and (iv) generating a 3D output image by combining the first conversion image with the second conversion image.

In an exemplary embodiment of the above method, the first scaling value and the second scaling value may be determined based at least on the depth information of the input image.

In an exemplary embodiment of the above method, the first conversion image may be superimposed onto the second conversion image to create a 3D perspective effect.

In particular embodiments, the present disclosure further contemplates an electronic system that comprises a processor and an image processing device. In the electronic system, the image processing device may be coupled to the processor and operatively configured by the processor to perform the following: (i) generate a first 2D image and a second 2D image by dividing an input image based on color information of the input image and depth information of the input image; (ii) generate a first conversion image by resizing the first 2D image based on a first scaling value and further generate a second conversion image by resizing the second 2D image based on a second scaling value different from the first scaling value; and (iii) generate an output image having a 3D perspective effect by combining the first conversion image with the second conversion image.

In an exemplary embodiment of the above system, the image processing device may be implemented in the processor.

In another exemplary embodiment, the electronic system may further include a graphic processor. The graphic processor may be coupled to the processor, but separate from the processor. The image processing device may be implemented in the graphic processor.

In an exemplary embodiment, the electronic system may further include an image pickup module that is coupled to the processor and the image processing device. The image pickup module may be operatively configured by the processor to obtain the color information of the input image and the depth information of the input image.

In one embodiment, the electronic system may further include an image pickup module and a depth measurement module, each of which may be coupled to the processor and the image processing device. The image pickup module may be operatively configured by the processor to obtain the color information of the input image. On the other hand, the depth measurement module may be operatively configured by the processor to obtain the depth information of the input image.

In an exemplary embodiment, the electronic system may be one of the following: a mobile phone, a smart phone, a tablet computer, a laptop computer, a personal digital assistants (PDA), a portable multimedia player (PMP), a digital camera, a portable game console, a music player, a camcorder, a virtual reality (VR) systen, a robotic system, a video player, and a navigation system.

### BRIEF DESCRIPTION OF THE DRAWINGS

Illustrative, non-limiting exemplary embodiments of the present disclosure will be more clearly understood from the following detailed description taken in conjunction with the accompanying drawings, in which:

FIG. 1 is an exemplary block diagram illustrating an image processing device according to one embodiment of the present disclosure;

FIGS. 2, 3, 4, 5, 6, 7, and 8 are exemplary illustrations used for describing the operation of the image processing device according to particular embodiments of the present disclosure;

FIGS. 9 and 10 are exemplary block diagrams of an image segmenter that may be included in the image processing device according to certain embodiments of the present disclosure;

FIGS. 11 and 12 are exemplary block diagrams of a scaler that may be included in the image processing device according to certain embodiments of the present disclosure;

FIGS. 13, 14, and 15 are exemplary block diagrams illustrating architectural details of an image processing device according to particular embodiments of the present disclosure;

FIG. 16 is an exemplary flowchart illustrating a method of image processing according to one embodiment of the present disclosure;

FIG. 17 is an exemplary block diagram illustrating an image processing device according to one embodiment of the present disclosure;

FIGS. 18, 19, and 20 are exemplary illustrations used for describing the operation of the image processing device according to the embodiment of FIG. 17;

FIG. 21 is an exemplary flow chart illustrating a method of image processing according to one embodiment of the present disclosure;

FIGS. 22, 23, 24A, 24B, and 25 are exemplary illustrations used for describing a 3D perspective effect that may be provided using an image processing device according to one embodiment of the present disclosure; and

FIGS. 26, 27, and 28 are exemplary block diagrams illustrating an electronic system according to particular embodiments of the present disclosure.

### DETAILED DESCRIPTION OF THE EMBODIMENTS

Various exemplary embodiments of the present disclosure now will be described more fully below with reference to the accompanying drawings, in which the embodiments are shown. The teachings of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or through one or more intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). In the context of the present disclosure, the coupling or connection between two elements may be primarily electrical.

It will be understood that, although the terms “first”, “second”, etc., may be used herein to describe various elements, these elements should not be limited by these terms. These terms are only used to distinguish one element from the other and, hence, these terms should not be construed to imply any specific order or sequence of these elements, unless noted otherwise or dictated by the context of discussion. For example, a “first scaling value” could be termed a “second scaling value”, and, similarly, a “second scaling value” could be termed a “first scaling value” without departing from the teachings of the disclosure.

The terminology used herein is for the purpose of describing particular embodiments and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” or other such terms of similar import, when used herein, refer to the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and should not be interpreted in an idealized or overly formal sense unless expressly so defined herein.

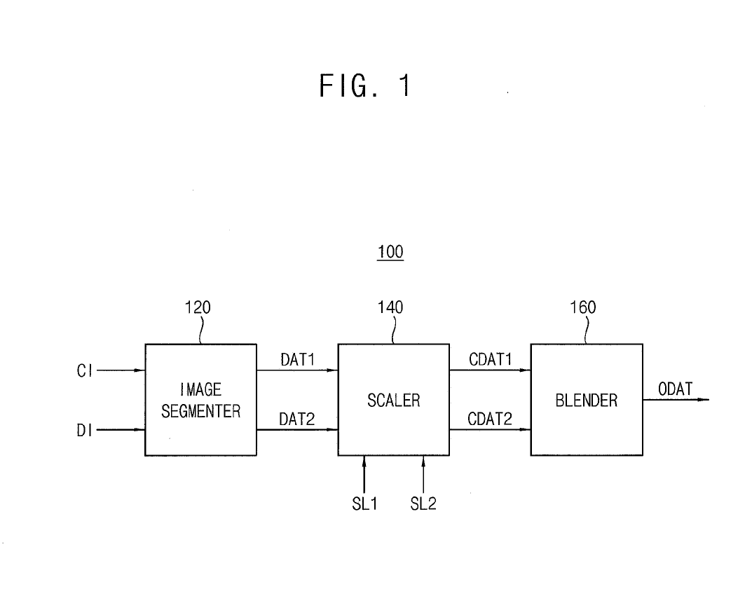

FIG. 1 is an exemplary block diagram illustrating an image processing device 100 according to one embodiment of the present disclosure. The image processing device 100 may be part of an electronic system (not shown). The electronic system may be a multimedia or audio-visual equipment such as, for example, a mobile phone, a smartphone, a tablet computer, a laptop computer, a VR or robotic system, a Personal Digital Assistant (PDA), a Portable Media Player (PMP), a digital camera, a portable game console, a music player, a camcorder, a video player, a navigation system, and the like.

Referring to FIG. 1, the image processing device 100 may include an image segmenter 120, a scaler 140, and a blender 160.

The image segmenter 120 may generate a first 2D image (more simply, and occasionally interchangeably, the “first image”) and a second 2D image (more simply, and occasionally interchangeably, the “second image”) by dividing an input image based on color information (CI) of the input image and depth information (DI) of the input image. Each of the first and the second images may be a portion of the input image. The image segmenter 120 may receive the color information CI of the input image and the depth information DI of the input image from an external device (e.g., an image pickup module, an image pickup device, etc.) (not shown) or an internal storage device (not shown), and may generate and output first image data DAT1 corresponding to the first image and second image data DAT2 corresponding to the second images. The color information CI may be provided as compressed data or uncompressed data.

The scaler 140 may generate a first conversion image by resizing the first image based on a first scaling value SL1, and may also generate a second conversion image by resizing the second image based on a second scaling value SL2 different from the first scaling value SL1. The scaler 140 may receive the first image data DAT1 and the second image data DAT2 from the image segmenter 120, and may generate and output first conversion image data CDAT1 corresponding to the first conversion image and second conversion image data CDAT2 corresponding to the second conversion image. The first conversion image data CDAT1 and the second conversion image data CDAT2 may be substantially simultaneously (or concurrently) generated, or may be sequentially generated.

In some exemplary embodiments, the first and second scaling values SL1 and SL2 may be determined based on the depth information DI of the input image, or may be determined by a user of the image processing device 100.

The blender 160 may generate an output image by combining the first conversion image with the second conversion image. The blender 160 may receive the first conversion image data CDAT1 and the second conversion image data CDAT2 from the scaler 140, and may generate output image data ODAT corresponding to the output image. The output image data ODAT thus facilitate generation of the output image.

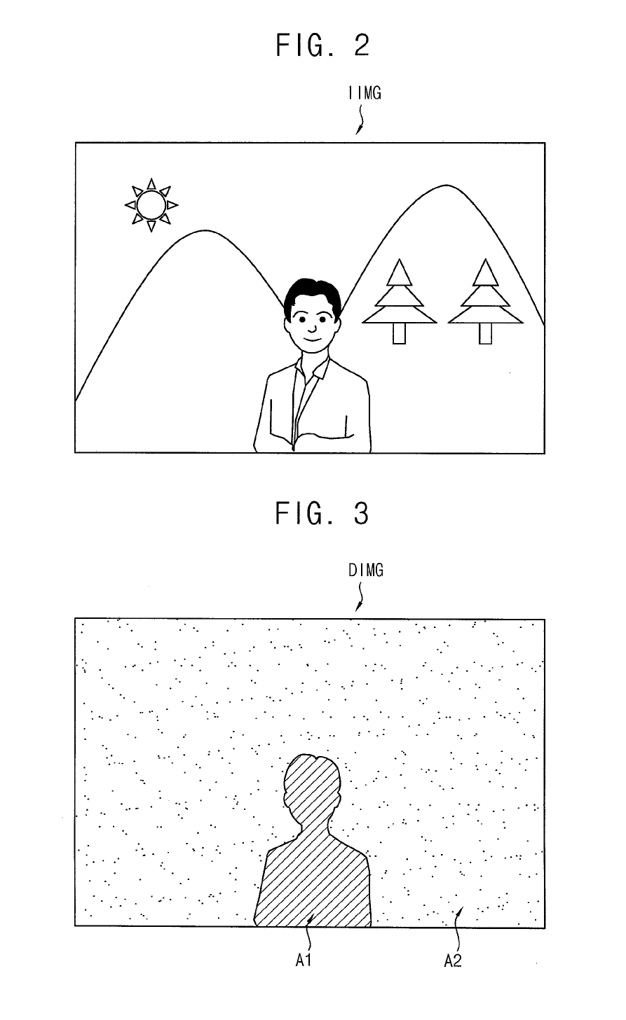

FIGS. 2, 3, 4, 5, 6, 7, and 8 are are exemplary illustrations used for describing the operation of the image processing device according to particular embodiments of the present disclosure. The image processing device may be device 100 shown in FIG. 1.

Referring to FIGS. 1 through 8, an input image IIMG of FIG. 2 may include an object (e.g., a man, a human, or a person) and a background (e.g., the sun, mountains, trees, etc.). The input image IIMG may be provided (to the image processing device 100) as input image data, and the color information CI may be obtained from the input image data.

The color information CI may include any type of color data. For example, the color data may have one of various image formats, such as RGB (Red, Green, Blue), YUV (Luminance-Bandwidth-Chrominance), YCbCr (Luminance, Chroma-Blue, Chroma-Red in digital video), YPbPr (also referred to as “component video” is the analog version of the YCbCr color space), etc.

The input image data may include color data substantially the same as the color information CI, or may include coding data that are generated by encoding the color information CI. For example, the coding data may be generated based on one of various coding schemes, such as JPEG (Joint Photographic Experts Group), MPEG (Moving Picture Expert Group), H.264, HEVC (High Efficiency Video Coding), etc.

In some exemplary embodiments, when the input image data includes the coding data, the image processing device 100 of FIG. 1 may further include a decoding unit (not illustrated) that generates the color information CI (e.g., RGB, YUV, YCbCr, YPbPr, etc.) by decoding the coding data.

A depth image DIMG of FIG. 3 may include an object region A1 and a background region A2. The depth image DIMG may be provided (to the image processing device 100) as depth image data, and the depth information DI may be obtained from the depth image data.

The depth information DI may include depth data for distinguishing the object and the background in the input image IIMG. For example, the depth information DI may include first depth data and second depth data. The first depth data may be data of the object region A1 corresponding to the object such that a distance between the object and the image pickup module (not shown) or a distance between the object and a person who captures the image is relatively short (e.g., is shorter than a reference distance). The second depth data may be data of the background region A2 corresponding to the background such that a distance between the background and the image pickup module is relatively long (e.g., is longer than the reference distance).

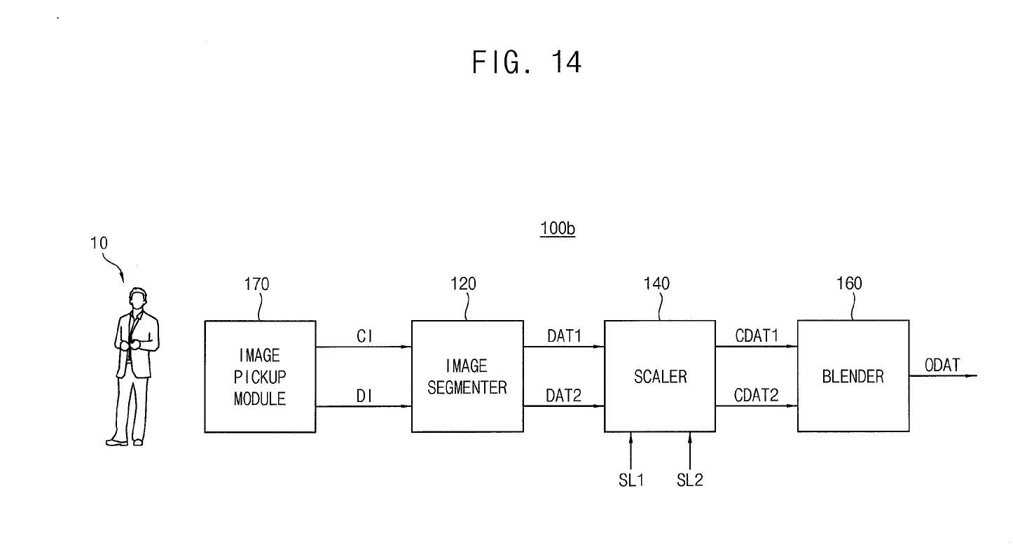

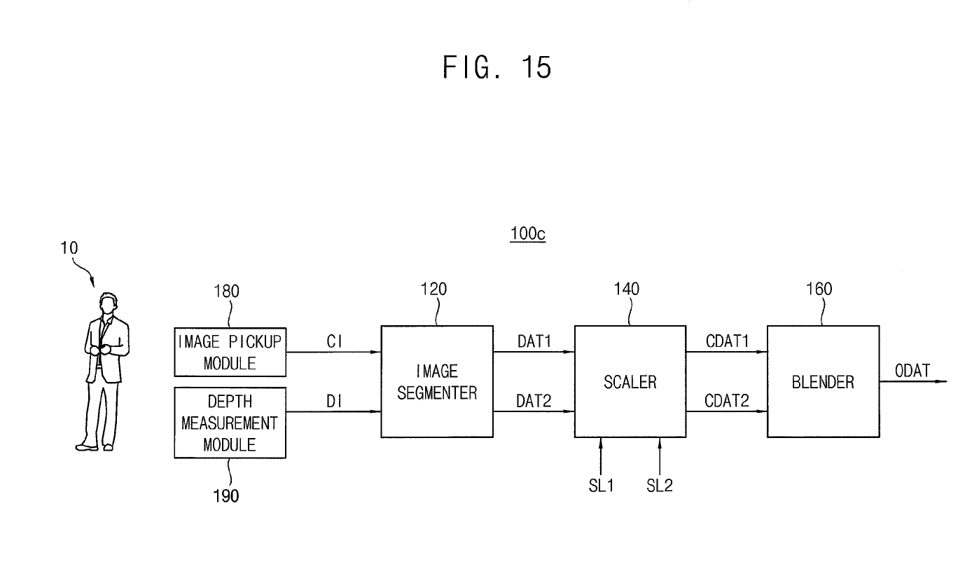

In some exemplary embodiments, the color information CI and the depth information DI may be obtained at initiation of the image processing. The color information CI and the depth information DI may be substantially simultaneously or sequentially obtained. For example, the color information CI and the depth information DI may be obtained from a single module (e.g., an image pickup module 170 in FIG. 14), or may be obtained from two separated modules (e.g., an image pickup module 180 in FIG. 15 and a depth measurement module 190 in FIG. 15), respectively.

In some exemplary embodiments, the color information CI and the depth information DI may be pre-stored in a storage unit (not illustrated), and may be loaded from the storage unit at the initiation of the image processing.

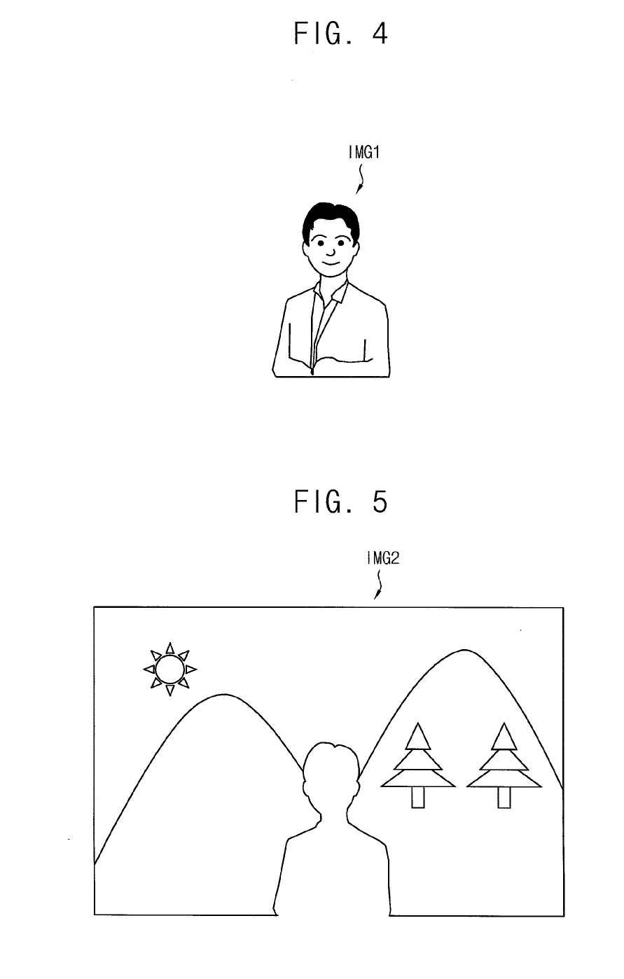

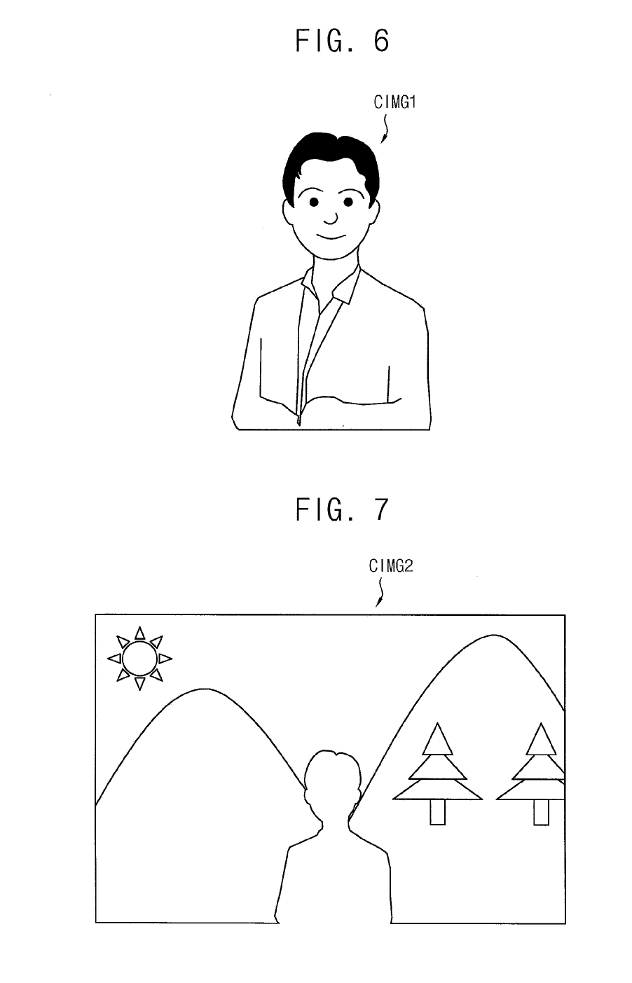

The image segmenter 120 may divide the input image IIMG into a first image IMG1 of FIG. 4 and a second image IMG2 of FIG. 5 based on the color information CI and the depth information DI. For example, the first image IMG1 may be a 2D image portion that is included in the input image IIMG, and may be an image (e.g., an object image) of the object region A1 corresponding to the object. The second image IMG2 also may be a 2D image portion that is included in the input image IIMG, and may be an image (e.g., a background image) of the background region A2 corresponding to the background. In other words, the first image IMG1 may be associated with the object in the input image IIMG, and the second image IMG2 may be associated with the background other than the object in the input image IIMG.

The scaler 140 may scale the first image IMG1 based on the first scaling value SL1, and may scale the second image IMG2 based on the second scaling value SL2. In other words, the scaler 140 may change the size of the first image IMG1 based on the first scaling value SL1, and also may change the size of the second image IMG2 based on the second scaling value SL2. As mentioned earlier, in particular embodiments, the scaling values SL1 and SL2 may be determined based on the depth information DI of the input image IIMG or may be user-supplied.

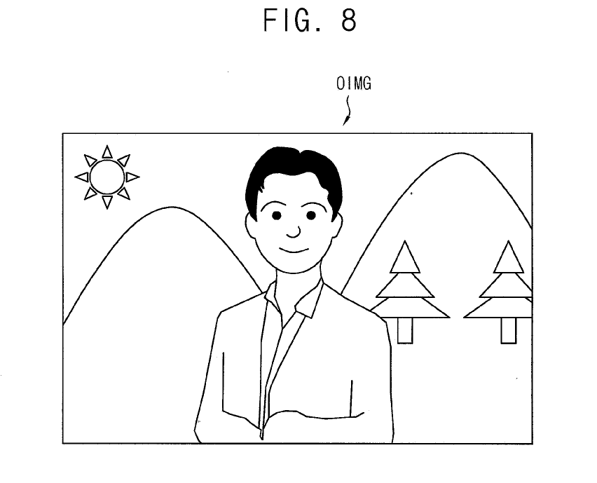

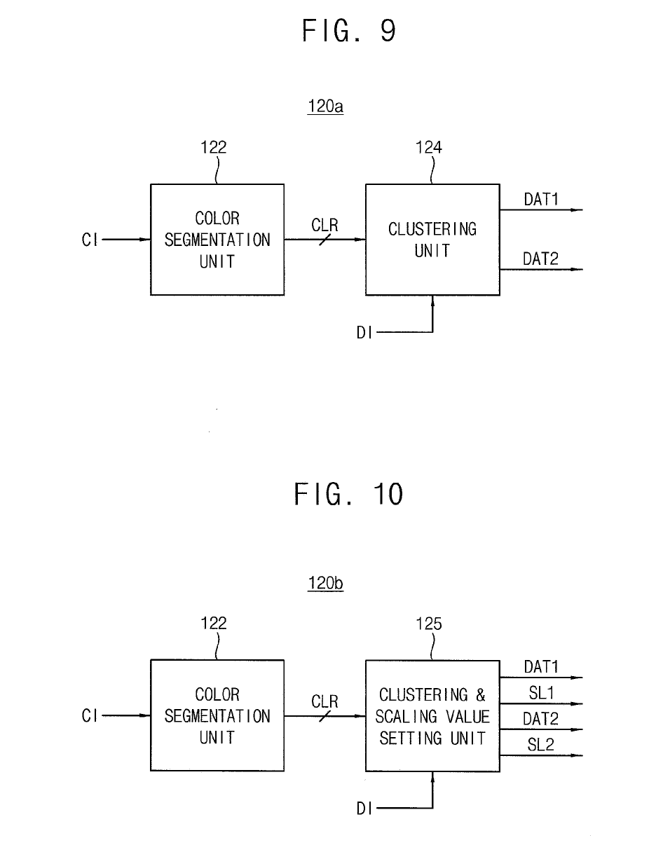

In some exemplary embodiments, the scaler 140 may perform an up-scaling in which the first and the second images IMG1 and IMG2, respectively, are enlarged. The up-scaling may be part of a zoom-in operation. However, contrary to the current approaches to such up-scaling, in particular embodiments of the present disclosure, each image may be enlarged differently—using a different scaling value. For example, the scaler 140 may generate a first conversion image CIMG1 of FIG. 6 by magnifying the first image IMG1 based on the first scaling value SL1, and may generate a second conversion image CIMG2 of FIG. 7 by magnifying the second image IMG2 based on the second scaling value SL2. In other words, the first conversion image CIMG1 may be a magnified image (or an enlarged image) of the first image IMG1, and the second conversion image CIMG2 may be a magnified image of the second image IMG2. It is observed from a comparison of the conversion images CIMG1 and CIMG2 in FIGS. 6 and 7, respectively, that the first image IMG1 is enlarged more (with a higher scaling value SL1) than the second image IMG2.

In some exemplary embodiments, to display the second conversion image CIMG2 on the same screen (or a display panel, a display device, etc.) and with the same size of display as that used for the second image IMG2, the second conversion image CIMG2 may be obtained by cutting off (or by truncating) edge regions of the magnified second image. The scaler 140, the blender 160, and/or an image cutting unit (not illustrated) in the image processing device 100 may be configured to perform the operation of cutting off the edge regions of the magnified second image.

When the first image IMG1 and the first conversion image CIMG1 are sequentially displayed on the same screen, or when the second image IMG2 and the second conversion image CIMG2 are sequentially displayed on the same screen, the user may recognize an effect whereby the object and/or the background become closer to the user's eyes. The operation of sequentially displaying an original image and a magnified image may be referred to as a zoom-in or a zoom-up operation.

In some exemplary embodiments, when the zoom-in is performed, the first scaling value SL1 may be greater than the second scaling value SL2. In the zoom-in, the first scaling value SL1 may indicate (or represent or correspond to) a magnification factor for the first image IMG1, and the second scaling value SL2 may indicate a magnification factor for the second image IMG2. For example, in case of FIGS. 2, 3, 4, and 5, the first scaling value SL1 may be about 2 (SL1=2), and the second scaling value SL2 may be about 1.2 (SL2=1.2). In other words, the size of the first conversion image CIMG1 (FIG. 6) may be about twice larger than the size of the first image IMG1, and the second conversion image CIMG2 (FIG. 7) may be magnified to about 1.2 times from the second image IMG2.

The blender 160 may generate the output image OIMG of FIG. 8 based on the first conversion image CIMG1 and the second conversion image CIMG2—as represented by the first conversion image data CDAT1 and the second conversion image data CDAT2, respectively. For example, in particular embodiments, the output image OIMG may be generated by simply combining (e.g., overlapping) the first conversion image CIMG1 with the second conversion image CIMG2.

In some exemplary embodiments, to remove an empty region in the second conversion image CIMG2, the output image OIMG may be generated by superimposing the first conversion image CIMG1 onto the second conversion image CIMG2. In other words, the magnified object may be superimposed onto the magnified background.

The output image OIMG of FIG. 8 may be a magnified image (or an enlarged image) of the input image IIMG of FIG. 2. In other words, the output image OIMG in FIG. 8 may be obtained by performing the zoom-in on the input image IIMG. The output image OIMG may be generated based on the input image IIMG by relatively large-scaling the first image IMG1 and by relatively small-scaling the second image IMG2 (e.g., by determining a magnification factor for the object greater than a magnification factor for the background). Thus, a three-dimensional (3D) perspective effect may be represented between the object and the background in the output image OIMG. In other words, the output image OIMG may be a 3D image resulting from disparate scaling of two or more 2D portions of the input image IIMG.

In the image processing device 100 according to certain exemplary embodiments, a scaling operation for generating the scaled output image OIMG may be performed on different 2D portions in the input image IIMG with different ratios. In particular embodiments, these 2D portions may be substantially non-overlapping. For example, as discussed before, the scaling operation may be performed on a 2D partial image for the object based on a first ratio, and the scaling operation may be performed on a 2D partial image for the background based on a second ratio different from (e.g., smaller than) the first ratio. The scaled output image OIMG may be generated by combining the scaled partial images with each other. Accordingly, the image processing device 100 may effectively generate the scaled output image OIMG with the 3D perspective effect, and the 3D perspective effect may be efficiently represented in the scaled output image OIMG. In other words, the image processing device 100 may generate the 3D scaled output image OIMG based on only a two-dimensional (2D) image processing (e.g., a 2D scaling operation) and without a 3D coordinate calculation. Thus, the 3D perspective effect may be represented in the output image OIMG in real time, with a relatively small calculation and resource (e.g., with a relatively small processing workload and low processing cost).

Although the exemplary embodiments in FIGS. 2 through 8 are described based on an example where the zoom-in is performed on the input image IIMG (e.g., the input image IIMG is enlarged), similar operations may be employed in case of an example where a zoom-out or a zoom-back is to be performed on the input image IIMG (e.g., the input image IIMG is reduced). Unlike the zoom-in, however, the user may recognize a different effect in the zoom-out operation where the object and/or the background become farther away from the user's eyes. Although not illustrated in FIGS. 2 through 8, the zoom-out operation will be explained below in more detail.

In some exemplary embodiments, the scaler 140 may perform a down-scaling (such as, for example, in case of a zoom-out operation) in which the first and the second images IMG1 and IMG2 are reduced. For example, the scaler 140 may generate a third conversion image (not shown) by demagnifying the first image IMG1 based on a third scaling value SL3, and may generate a fourth conversion image (not shown) by demagnifying the second image IMG2 based on a fourth scaling value SL4. To display the fourth conversion image on the same screen and with the same size of display as that used for the second image IMG2, the fourth conversion image may be obtained by performing additional image processing for the demagnified second image. For example, at least a portion (e.g., edge regions) of the demagnified second image may be copied, and the copied portion may be pasted at sides of the demagnified second image. The scaler 140, the blender 160, and/or an image reconfiguration unit (not illustrated) in the image processing device 100 may be configured to perform such additional image processing for the demagnified second image. When the zoom-out is performed, the third scaling value may be smaller than the fourth scaling value. In the zoom-out, the third scaling value may indicate (or represent or correspond to) a demagnification factor for the first image IMG1, and the fourth scaling value may indicate a demagnification factor for the second image IMG2. For example, the third scaling value may be about 0.5 (SL3=0.5), and the fourth scaling value may be about 0.8 (SL4=0.8). In other words, the size of the third conversion image may be about one half of the size of the first image IMG1, and the fourth conversion image may be demagnified to about 0.8 times from the second image IMG2.

Although the exemplary embodiments in FIGS. 2 through 8 are described based on an example where the first image IMG1 is associated with the object and the second image IMG2 is associated with the background, in some other embodiments each of the first and second images may be associated with an object in one image. For example, when the input image IIMG is divided into two 2D partial images, one of the two partial images may be associated with a first object (e.g., a human) in the input image IIMG, and the other of the two partial images may be associated with a second object (e.g., trees) in the input image IIMG different from the first object. The scaling operation (e.g., the up-scaling or the down-scaling) may be performed on these two partial images in the input image IIMG with different ratios, as discussed before.

In addition, although the exemplary embodiments in FIGS. 2 through 8 are described based on an example where the input image IIMG is a static image (e.g., a still image, a stopped image, a photograph, etc.) or a single frame image, in other embodiments the input image may be a dynamic image (e.g., a moving image, a video, etc.). When the input image is a dynamic image, the scaling operation (e.g., the up-scaling or the down-scaling) may be performed on each of a plurality of 2D frame images in the dynamic image.

FIGS. 9 and 10 are exemplary block diagrams of an image segmenter that may be included in the image processing device 100 according to certain embodiments of the present disclosure. FIG. 9 shows one embodiment of such an image segmenter, whereas FIG. 10 shows another (different) embodiment of the image segmenter.

Referring to FIG. 9, an image segmenter 120a may include a color segmentation unit 122 and a clustering unit 124.

The color segmentation unit 122 may generate a plurality of color data CLR by performing a color classification on the input image (e.g., IIMG of FIG. 2) based on the color information CI of the input image. The color classification may be an operation in which the input image is divided into a plurality of image blocks and/or an operation in which image blocks having the same color (or similar color) are checked. In particular embodiments, for example, each of the plurality of image blocks may include at least two pixels (e.g., image blocks of 2*2 or 3*3 pixels).

The clustering unit 124 may generate the first image data DAT1 corresponding to the first 2D image (e.g., IMG1 of FIG. 4) and the second image data DAT2 corresponding to the second 2D image (e.g., IMG2 of FIG. 5) based on the plurality of color data CLR and the depth information DI of the input image.

Similar to the color information CI, each of the first and the second image data DAT1 and DAT2, respectively, may include any type of color data. In particular embodiments, each of the first and the second image data DAT1 and DAT2, respectively, may further include position information. The position information may indicate locations of the first and the second 2D images in the input image. For example, the position information may be provided as a flag value. Each of a plurality of first pixel data included in the first image data DAT1 may have a first flag value, and each of a plurality of second pixel data included in the second image data DAT2 may have a second flag value.

Referring to FIG. 10, an image segmenter 120b may include a color segmentation unit 122 and a clustering and scaling value setting unit 125.

The image segmenter 120b of FIG. 10 may be substantially the same as the image segmenter 120a of FIG. 9, except that the clustering unit 124 in FIG. 9 is replaced with the clustering and scaling value setting unit 125 in FIG. 10. The color segmentation unit 122 in FIG. 10 may be substantially the same as the color segmentation unit 122 in FIG. 9.

The clustering and scaling value setting unit 125 may generate the first image data DAT1 corresponding to the first image and the second image data DAT2 corresponding to the second image based on the plurality of color data CLR and the depth information DI. In addition, the clustering and scaling value setting unit 125 may be configured to determine the first scaling value SL1 and the second scaling value SL2 based on the depth information DI.

In some exemplary embodiments, the first and the second scaling values SL1 and SL2, respectively, may be determined based on a first distance and a second distance. The first distance may indicate a distance between the image pickup module (or a person who captures the image) (not shown) and the object corresponding to the first image, and the second distance may indicate a distance between the image pickup module and the background corresponding to the second image. For example, when the first distance is shorter than the second distance in the zoom-in operation, the first scaling value SL1 may be greater than the second scaling value SL2. When the second distance is shorter than the first distance in the zoom-in operation, the second scaling value SL2 may be greater than the first scaling value SL1. When the first distance is shorter than the second distance in the zoom-out operation, the first scaling value SL1 may be smaller than the second scaling value SL2. When the second distance is shorter than the first distance in the zoom-out operation, the second scaling value SL2 may be smaller than the first scaling value SL1.

In some exemplary embodiments, the first scaling value SL1 may decrease in the zoom-in operation as the first distance increases. The first scaling value SL1 may increase in the zoom-in operation as the first distance decreases. On the other hand, the first scaling value SL1 may increase in the zoom-out operation as the first distance increases. The first scaling value SL1 may decrease in the zoom-out operation as the first distance decreases. Similar to the first scaling value SL1, the second scaling value SL2 may decrease in the zoom-in operation as the second distance increases. The second scaling value SL2 may increase in the zoom-in operation as the second distance decreases. Similarly, the second scaling value SL2 may increase in the zoom-out operation as the second distance increases. The second scaling value SL2 may decrease in the zoom-out as the second distance decreases.

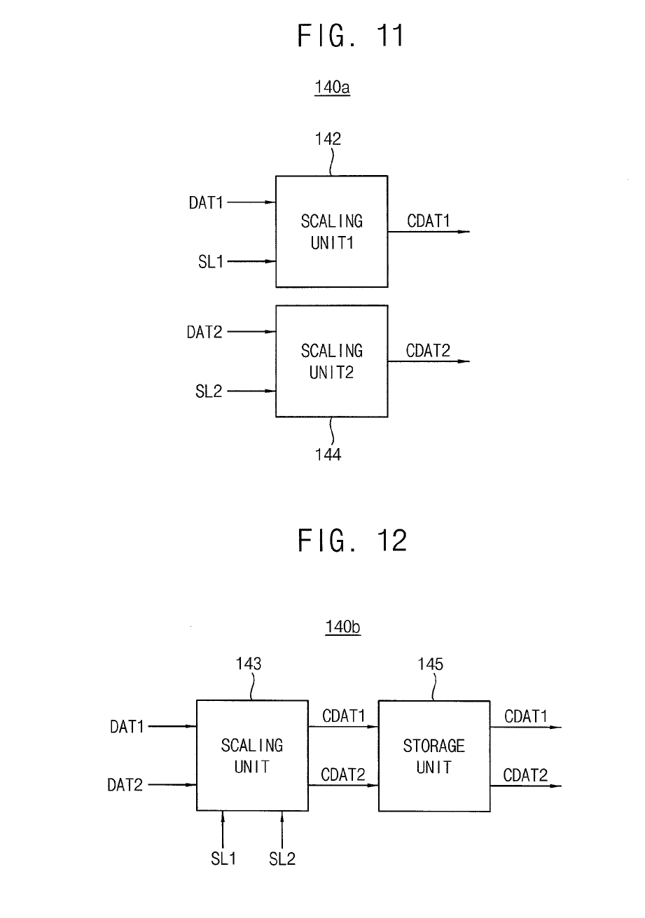

FIGS. 11 and 12 are exemplary block diagrams of a scaler that may be included in the image processing device 100 according to certain embodiments of the present disclosure. FIG. 11 shows one embodiment of such a scaler, whereas FIG. 12 shows another (different) embodiment of the scaler.

Referring to FIG. 11, a scaler 140a may include a first scaling unit 142 and a second scaling unit 144.

The first scaling unit 142 may generate the first conversion image data CDAT1 corresponding to the first conversion image (e.g., CIMG1 of FIG. 6) based on the first scaling value SL1 and the first image data DAT1 corresponding to the first image (e.g., IMG1 of FIG. 4). The second scaling unit 144 may generate the second conversion image data CDAT2 corresponding to the second conversion image (e.g., CIMG2 of FIG. 7) based on the second scaling value SL2 and the second image data DAT2 corresponding to the second image (e.g., IMG2 of FIG. 5). In certain embodiments, the first conversion image data CDAT1 and the second conversion image data CDAT2 may be substantially simultaneously generated. In other embodiments, the first conversion image data CDAT1 and the second conversion image data CDAT2 may be sequentially generated.

In one embodiment, in the zoom-in operation, the up-scaling may be performed by the first and the second scaling units 142 and 144, respectively, with different ratios to generate the data (CDAT1 and CDAT2) for the the first conversion image (e.g., based on the first image and the first scaling value SL1) and the second conversion image (e.g., based on the second image and the second scaling value SL2), respectively. In another embodiment, in the zoom-out operation, the down-scaling may be performed by the first and the second scaling units 142 and 144, respectively, with different ratios to generate the data for the first conversion image and the second conversion image.

Similar to the first image data DAT1 and the second image data DAT2, each of the first conversion image data CDAT1 and the second conversion image data CDAT2 may include any type of color data, and may further include position information that indicates locations of the first and the second conversion images in the output image.

Referring now to FIG. 12, a scaler 140b may include a scaling unit 143 and a storage unit 145.

The scaling unit 143 may be considered as a combination of the first scaling unit 142 and the second scaling unit 144 of FIG. 11. In other words, the scaling unit 143 may have the functionality of the scaler 140a in FIG. 11. Hence, as shown in FIG. 12, the scaling unit 143 may generate the first conversion image data CDAT1 based on the first scaling value SL1 and the first image data DAT1, and may also generate the second conversion image data CDAT2 based on the second scaling value SL2 and the second image data DAT2. In certain embodiments, the first and the second conversion image data CDAT1 and CDAT2, respectively, may be sequentially generated. In other embodiments, the first conversion image data CDAT1 and the second conversion image data CDAT2 may be generated substantially simultaneously.

In one embodiment, in the zoom-in operation, the up-scaling may be sequentially performed on the first and the second image data DAT1 and DAT2, respectively, by the scaling unit 143 (with different ratios) to generate the first conversion image data and the second conversion image data. In another embodiment, in the the zoom-out operation, the down-scaling may be sequentially performed on the first and the second image data by the scaling unit 143 (with different ratios) to generate the first conversion image data and the second conversion image data.

The storage unit 145 may sequentially store the first and the second conversion image data CDAT1 and CDAT2, and may substantially simultaneously output the first and the second conversion image data CDAT1 and CDAT2. Alternatively, the storage unit 145 may be configured to substantially simultaneously store the first and the second conversion image data CDAT1 and CDAT2, respectively.

In some exemplary embodiments, the storage unit 145 may include at least one volatile memory, such as a dynamic random access memory (DRAM), a static random access memory (SRAM), and/or at least one nonvolatile memory, such as an electrically erasable programmable read-only memory (EEPROM), a flash memory, a phase change random access memory (PRAM), a resistance random access memory (RRAM), a magnetic random access memory (MRAM), a ferroelectric random access memory (FRAM), a nano floating gate memory (NFGM), or a polymer random access memory (PoRAM).

Although not illustrated in FIG. 12, in particular embodiments, the storage unit 145 may be located outside the scaler 140b. For example, the storage unit may be located inside the blender 160 in FIG. 1, or may be located elsewhere in the image processing device 100 of FIG. 1.

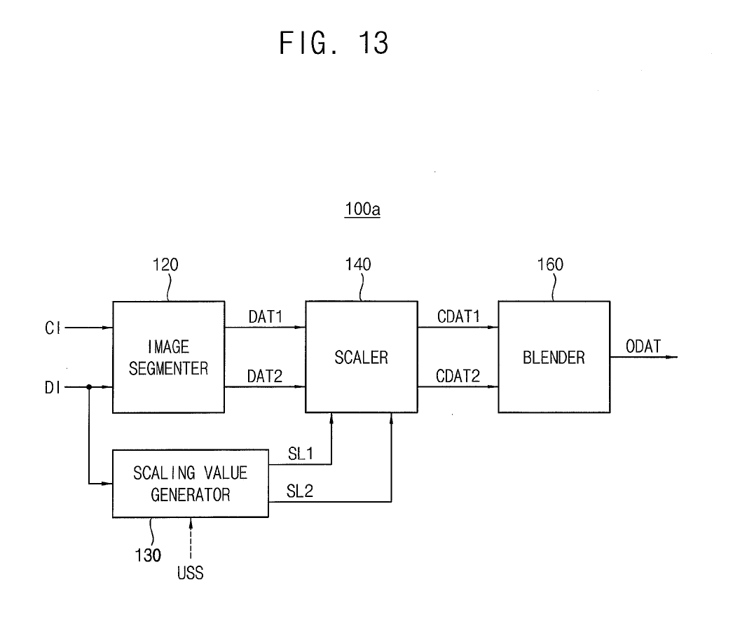

FIGS. 13, 14, and 15 are exemplary block diagrams illustrating architectural details of an image processing device according to particular embodiments of the present disclosure. FIG. 13 shows one embodiment of such an image processing device, FIG. 14 shows another (different) embodiment, and FIG. 15 shows yet another embodiment of the image processing device. Each of the embodiments shown in FIGS. 13-15 may be considered as architectural variations of the more general embodiment of the image processing device 100 shown in FIG. 1.

Referring now to FIG. 13, an image processing device 100a according to one embodiment of the present disclosure may not only include the image segmenter 120, the scaler 140, and the blender 160 shown in FIG. 1, but may also include a scaling value generator 130. Thus, the image processing device 100a of FIG. 13 may be substantially the same as the image processing device 100 of FIG. 1, except for the inclusion of the scaling value generator 130 in the image processing device 100a of FIG. 13. Thus, only a brief discussion of the additional aspects relevant to the embodiment in FIG. 13 is provided below.

The scaling value generator 130 may determine the first scaling value SL1 and the second scaling value SL2 based on the depth information DI. In one embodiment, the scaling value generator 130 may determine the first and the second scaling values SL1 and SL2, respectively, in substantially the same manner as those values determined by the clustering and scaling value setting unit 125 in FIG. 10.

In some exemplary embodiments, the scaling value generator 130 may further receive a user setting signal USS. The user setting signal USS may be provided from a user of the image processing device 100a or an electronic system including the image processing device 100a. In particular embodiments, the scaling value generator 130 may determine the first and the second scaling values SL1 and SL2, respectively, based on at least one of the depth information DI and the user setting signal USS.

When the image processing device 100a further includes the scaling value generator 130, the image segmenter 120 in FIG. 13 may be substantially the same as the image segmenter 120a of FIG. 9. Furthermore, the scaler 140 in FIG. 13 may be substantially the same as one of the scaler 140a of FIG. 11 or the scaler 140b of FIG. 12.

The image processing device 100b in the embodiment of FIG. 14 may also include the image segmenter 120, the scaler 140, and the blender 160 shown in FIG. 1. In addition, the image processing device 100b may further include an image pickup module 170. Thus, the image processing device 100b in FIG. 14 also may be substantially the same as the image processing device 100 of FIG. 1, except for the inclusion of the image pickup module 170 in the embodiment of FIG. 14. Thus, only a brief discussion of the additional aspects relevant to the embodiment of FIG. 14 is provided below.

The image pickup module 170 may capture an image (such as a photograph) that includes an object 10 (which may be a subject for the photograph), and also may obtain the color information CI and the depth information DI for the captured image. For example, the image pickup module 170 may include a lens (not illustrated) and a sensor (not illustrated). The sensor may substantially simultaneously obtain the color information CI and the depth information DI while capturing an input image via the lens.

In some exemplary embodiments, the sensor in the image pickup module 170 may be a 3D color image sensor. The 3D color image sensor may be referred to as an RGBZ sensor, which may include a plurality of depth (Z) pixels and a plurality of color (Red (R), Green (G), and Blue (B)) pixels in one pixel array (not shown). Furthermore, a plurality of infrared light filters (not shown) or a plurality of near-infrared light filters (not shown) may be arranged on the plurality of depth pixels, and a plurality of color filters (e.g., red, green, and blue filters) may be arranged on the plurality of color pixels. In particular embodiments, the depth (Z) pixels may provide the depth information DI, whereas the color (RGB) pixels may provide the color information CI for the input image being captured by the image pickup module 170.

Referring now to FIG. 15, the image processing device 100c in the embodiment of FIG. 15 may also include the image segmenter 120, the scaler 140, and the blender 160, like the image processing device 100 in FIG. 1. However, the image processing device 100c in the embodiment of FIG. 15 may further include an image pickup module 180 and a depth measurement module 190. Overall, the image processing device 100c in FIG. 15 may be substantially the same as the image processing device 100 of FIG. 1, except for the inclusion of the image pickup module 180 and the depth measurement module 190 in the embodiment of FIG. 15. Thus, only a brief discussion of the additional aspects relevant to the embodiment of FIG. 15 is provided below.

The image pickup module 180 may capture an image (such as a photograph) that includes the object 10 (which may be a subject for the photograph), and also may obtain the color information CI for the captured image. In particular embodiments, the image pickup module 180 may include a first lens (not illustrated) and a first sensor (not illustrated).

In some exemplary embodiments, the first sensor in the image pickup module 180 may be a 2D color image sensor. The 2D color image sensor may be referred to as an RGB sensor, and may include a plurality of color pixels arranged in a pixel array (not shown). The first sensor may be one of various types of image sensors, such as, for example, a complementary metal oxide semiconductor (CMOS) image sensor, a charge coupled device (CCD) image sensor, etc.

The depth measurement module 190 may capture an image that includes the object 10, and may also obtain the depth information DI for the captured image. In certain embodiments, the depth measurement module 190 may include a second lens (not illustrated), a light source (not illustrated), and a second sensor (not illustrated).

In some exemplary embodiments, the second sensor in the depth measurement module 190 may be a 3D image sensor. The 3D image sensor may be referred to as a depth sensor, and may include a plurality of depth pixels. For example, the second sensor may be one of various types of depth sensors that require a light source and adopt a time of flight (TOF) scheme, or a structured light scheme, or a patterned light scheme, or an intensity map scheme, etc. Furthermore, in oen embodiment, the pixels in the second sensor may be arranged in a pixel array (not shown) as well.

In paricular embodiments, the image segmenter 120 in at least one of the FIGS. 14 and 15 may be substantially the same as either the image segmenter 120a of FIG. 9 or the image segmenter 120b of FIG. 10. Furthermore, the scaler 140 in at least one of the FIGS. 14 and 15 also may be substantially the same as either the scaler 140a of FIG. 11 or the scaler 140b of FIG. 12. Although not shown, in some embodiments, the image processing device 100b of FIG. 14 or the image processing device 100c of FIG. 15 may further include a scaling value generator (e.g., like the scaling value generator 130 in FIG. 13).

Although the object 10 in FIGS. 14 and 15 is shown to be a human, the object captured by the image pickup module (in FIGS. 14-15) and/or the depth measurement module (in FIG. 15) may be any other object (e.g., tree, animal, car, etc.).

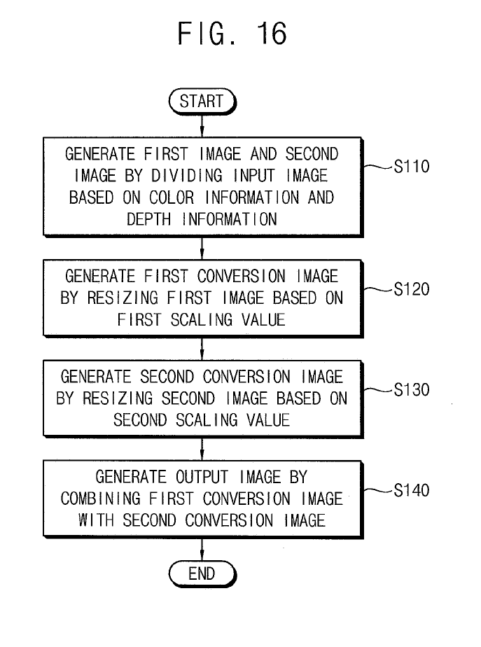

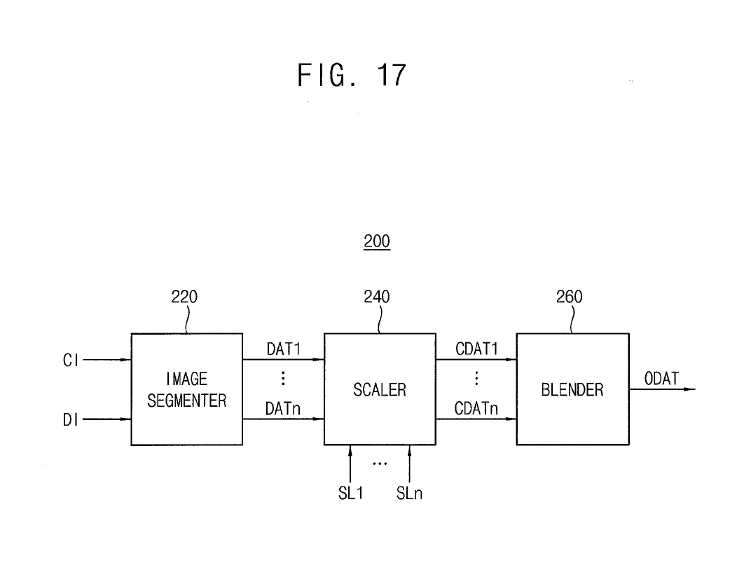

FIG. 16 is an exemplary flowchart illustrating a method of image processing according to one embodiment of the present disclosure.

In the method of image processing according to the embodiment in FIG. 16, a first image and a second image are generated by dividing an input image based on the color information of the input image and the depth information of the input image (step S110). As mentioned earlier, each of the first and the second images may be a separate and distinct 2D portion of the input image. In particular embodiments, such 2D portions may be substantially non-overlapping or, alternatively, may have a pre-defined overlap. The color information and the depth information may be obtained at the time of initiation of image processing, or may be pre-stored and loaded at the time of initiation of image processing.

According to the method in FIG. 16, a first conversion image may be generated by resizing the first image based on a first scaling value (step S120), and a second conversion image may be generated by resizing the second image based on a second scaling value different from the first scaling value (step S130). The scaling operation may be one of an up-scaling operation corresponding to a zoom-in request or a down-scaling operation corresponding to a zoom-out request.

Although not illustrated in FIG. 16, the first and the second scaling values may be determined as part of the methodology shown in FIG. 16. For example, the first and the second scaling values may be determined based on the depth information of the input image, or may be determined by a user.

An output image may be generated by combining the first conversion image with the second conversion image (step S140). For example, in one embodiment, the output image may be generated by superimposing the first conversion image onto the second conversion image.

The image processing method of FIG. 16 may be performed as described above with reference to FIGS. 1 through 8, and may be performed using any one of the image processing devices shown in FIG. 1, FIG. 13, FIG. 14, or FIG. 15.

In the method of image processing according to the embodiment of FIG. 16, the scaling operation (at steps S120 and S130) for generating the scaled output image may be performed on portions of the input image using different, portion-specific scaling ratios. Furthermore, as noted before, the scaled output image may be generated based on only the 2D scaling operation. Accordingly, the 3D perspective effect may be efficiently represented in the scaled output image in real time with a relatively small workload and low processing cost.

Although various embodiments are described hereinbefore based on an example where the input image is divided into two partial images (e.g., the object image and the background image), the teachings of the present disclosure may be applied to a situation where the input image is divided into any number of images. A scaling operation involving three or more partial images will be explained below in detail.

FIG. 17 is an exemplary block diagram illustrating an image processing device 200 according to one embodiment of the present disclosure.

Referring to FIG. 17, the image processing device 200 may include an image segmenter 220, a scaler 240, and a blender 260.

The image processing device 200 of FIG. 17 may be substantially the same as the image processing device 100 of FIG. 1, except that the image processing device 200 may be configured to operate on an input image that is divided into more than two partial images.

The image segmenter 220 may generate data for a plurality of 2D images—first through n-th images—by dividing an input image based on color information CI of the input image and depth information DI of the input image, where “n” is a natural number equal to or greater than three. Each of the first through n-th images may be a 2D portion of the input image. In particular embodiments, each such 2D portion may be substantially non-overlapping. The image segmenter 220 may receive the color information CI and the depth information DI from an external device or an internal storage device, may process the received CI and DI content, and consequently may generate and output first through n-th image data DAT1, DATn corresponding to the first through n-th images. In one embodiment, the image segmenter 220 may be similar to either the image segmenter 120a of FIG. 9 or the image segmenter 120b of FIG. 10.

The scaler 240 may generate first through n-th conversion images by resizing the first through n-th images—as represented by first through n-th image data received from the image segmenter 220—based on first through n-th scaling values SL1, SLn that are different from one another. More specifically, the scaler 240 may receive the first through n-th image data DAT1, DATn from the image segmenter 220, and may generate and output first through n-th conversion image data CDAT1, CDATn corresponding to the first through n-th conversion images. In one embodiment, the scaler 240 may be similar either the scaler 140a of FIG. 11 or the scaler 140b of FIG. 12. For example, the scaler 240 may include “n” scaling units (similar to the scaler in FIG. 11), or may include one scaling unit and one storage unit (like the scaler in FIG. 12).

In some exemplary embodiments, each of the first through n-th images may be scaled with a different, image-specific scaling ratio, or, alternatively, some of the first through n-th images may be scaled with the same ratio. For example, when the input image is divided into three images (e.g., when “n” is equal to three), the first image may be scaled based on a first scaling value, the second image may be scaled based on a second scaling value different from the first scaling value, and the third image may be scaled based on one of the first scaling value, the second scaling value, or a third scaling value different from the first and the second scaling values.

The blender 260 may generate an output image by combining the first through n-th conversion images with one another. More specifically, the blender 260 may receive the first through n-th conversion image data CDAT1, CDATn from the scaler 240, and may generate output image data ODAT corresponding to the output image. In particular embodiments, the output image may be rendered or displayed based on the generated output image data ODAT.

In some exemplary embodiments, the image processing device 200 may further include at least one of a scaling value generator (e.g., similar to the element 130 in FIG. 13), an image pickup module (e.g., similar to the element 170 in FIG. 14 or the element 180 in FIG. 15), and a depth measurement module (e.g., similar to the element 190 in FIG. 15).

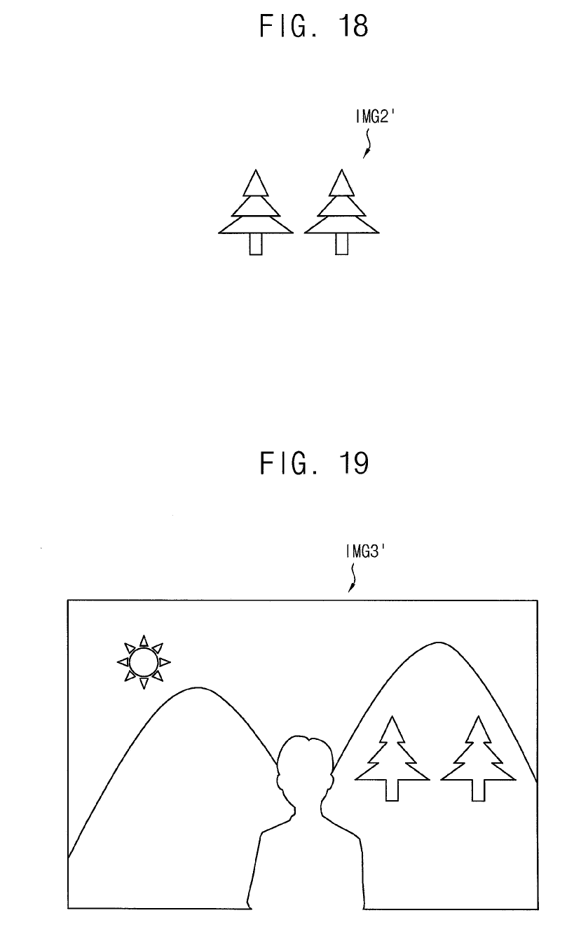

FIGS. 18, 19, and 20 are exemplary illustrations used for describing the operation of the image processing device 200 according to the embodiment of FIG. 17.

Referring to FIGS. 2, 4, 17, 18, 19, and 20, an input image IIMG of FIG. 2 may include a first object (e.g., a man, a human, or a person), a second object (e.g., trees), and a remaining background (e.g., the sun, mountains, etc.).

Although not illustrated, a depth image corresponding to the input image IIMG (in the context of the embodiment in FIG. 17) may include a first object region corresponding to the first object, a second object region corresponding to the second object, and a background region corresponding to the remaining background. Such a depth image may be similar to the depth image in FIG. 3, except for the presence of three depth regions (as opposed to only two regions—A1 (for the first object) and A2 (for the entire background)—in the depth image of FIG. 3).

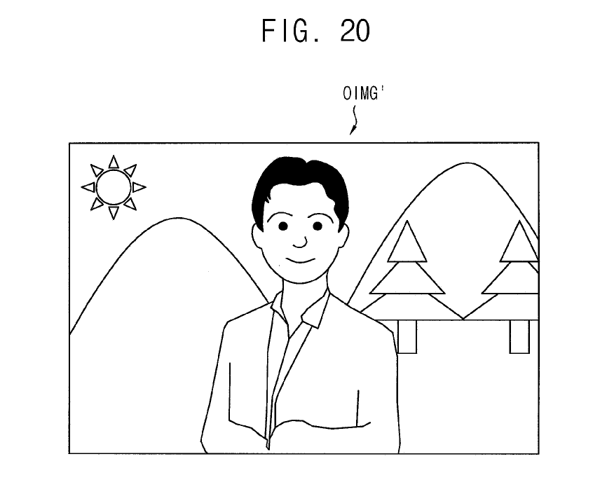

The image segmenter 220 may divide the input image IIMG into a first image IMG1 of FIG. 4, a second image IMG2′ of FIG. 18, and a third image IMG3′ of FIG. 19, based on the color information CI obtained from the input image IIMG and the depth information DI obtained from the corresponding 3-region depth image mentioned above. In the context of FIG. 19, is noted here that the human outline therein corresponds to the first image IMG1 of FIG. 4 and the trees therein indicate an outline of the trees in the second image IMG2′ of FIG. 18.

The scaler 240 may scale the first image IMG1 based on a first scaling value SL1 to generate a first conversion image, may scale the second image IMG2′ based on a second scaling value SL2 to generate a second conversion image, and may scale the third image IMG3′ based on a third scaling value SL3 to generate a third conversion image. In one embodiment, the scaler 240 may perform an up-scaling operation in which the first, the second, and the third images IMG1, IMG2′ and IMG3′, respectively, are enlarged. For example, in the example of FIGS. 2, 4, 18, 19, and 20, the first scaling value may be about 2 (SL1=2), the second scaling value may be about 1.5 (SL2=1.5), and the third scaling value may be about 1.2 (SL3=1.2).

The blender 260 may generate the output image OIMG′ of FIG. 20 based on the first, the second, and the third conversion images. For example, the output image OIMG′ in FIG. 20 may be generated by sequentially superimposing (e.g., overlapping) the second conversion image and the first conversion image onto the third conversion image.

The output image OIMG′ in FIG. 20 may be obtained by performing a zoom-in operation on the input image IIMG. The output image OIMG′ may be generated based on the input image IIMG by relatively large-scaling the first and the second images IMG1 (FIG. 4) and IMG2′ (FIG. 18), respectively, and by relatively small-scaling the third image IMG3′ (FIG. 19) (e.g., by determining the magnification factors for the objects in FIGS. 17-18 to be greater than the magnification factor for the remaining background in FIG. 19). Thus, the 3D perspective effect may be provided between the objects and the background in the output image OIMG′. As before, this 3D perspective effect may be achieved using a 2D image processing, which is relatively faster and less resource-intensive than a 3D coordinate calculation.

The foregoing discussion of the exemplary embodiments in FIGS. 1-20 may be applied to various other examples where the input image IIMG is divided into any number of 2D partial images, each of the partial images may include an object image or a background image. The zoom-in or the zoom-out operation may be performed on the input image IIMG using disparate scaling of such multiple partial images. Furthermore, the input image IIMG may be a static image or a dynamic image.

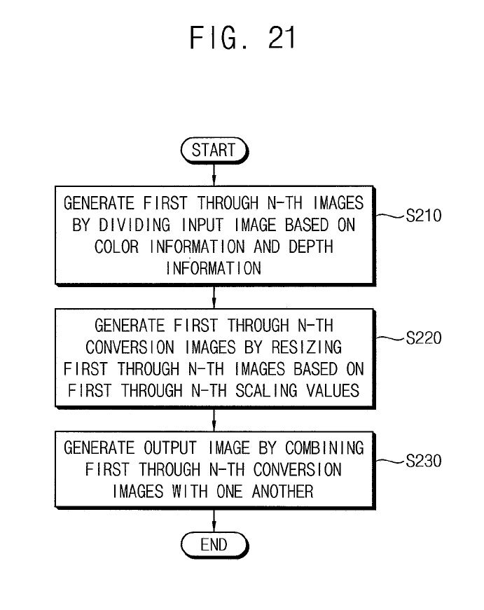

FIG. 21 is an exemplary flow chart illustrating a method of image processing according to one embodiment of the present disclosure.

In the method of image processing according to the embodiment in FIG. 21, first through n-th images are generated by dividing an input image based on the color information of the input image and the depth information of the input image (step S210). As mentioned earlier, each of these “n” images may be a separate and distinct 2D portion of the input image. In particular embodiments, these 2D portions may be substantially non-overlapping or, alternatively, may have a pre-defined overlap. Thereafter, first through n-th conversion images may be generated by resizing the first through the n-th images based on first through n-th scaling values (step S220). In one embodiment, each of these “n” scaling values may be different from one another and may be applied to a corresponding one of the 2D portion. An output image may be generated by combining the first through the n-th conversion images with one another (step S230). Although not illustrated in FIG. 21, the first through the n-th scaling values may be determined as part of the methodology shown in FIG. 21.

The step S210 in FIG. 21 may be analogized with the step S110 in FIG. 16, the step S220 in FIG. 21 may be analogized with the steps S120 and S130 in FIG. 16, and the step S230 in FIG. 21 may be analogized with the step S140 in FIG. 16.

In particular embodiments, the method of the image processing in FIG. 21 may be performed as described above (using the examples in FIGS. 2, 4, 17, 18, 19, and 20), and may be carried out using the the image processing device 200 of FIG. 17.

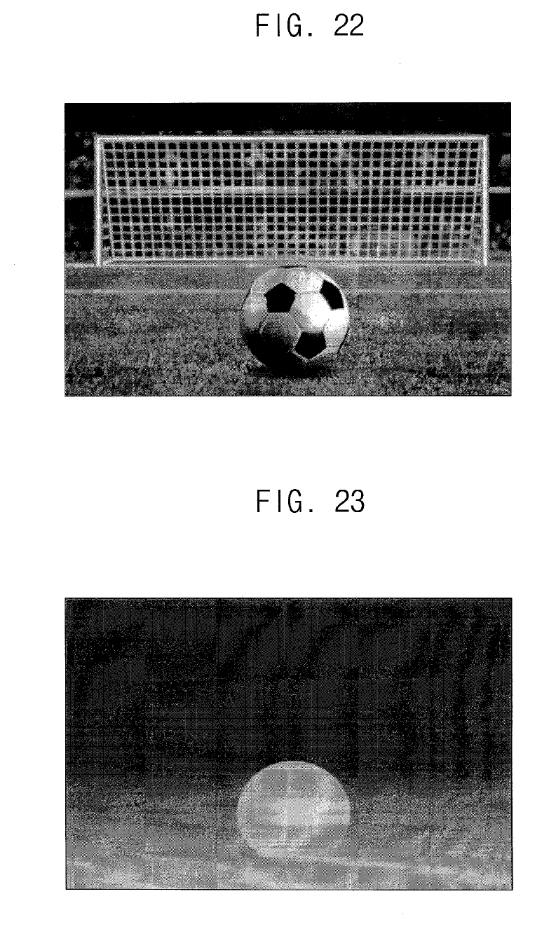

FIGS. 22, 23, 24A, 24B, and 25 are exemplary illustrations used for describing a 3D perspective effect that may be provided using an image processing device according to one embodiment of the present disclosure. The image processing device may be any one of the image processing devices shown in the embodiments of FIGS. 1, 13-15, and 17.

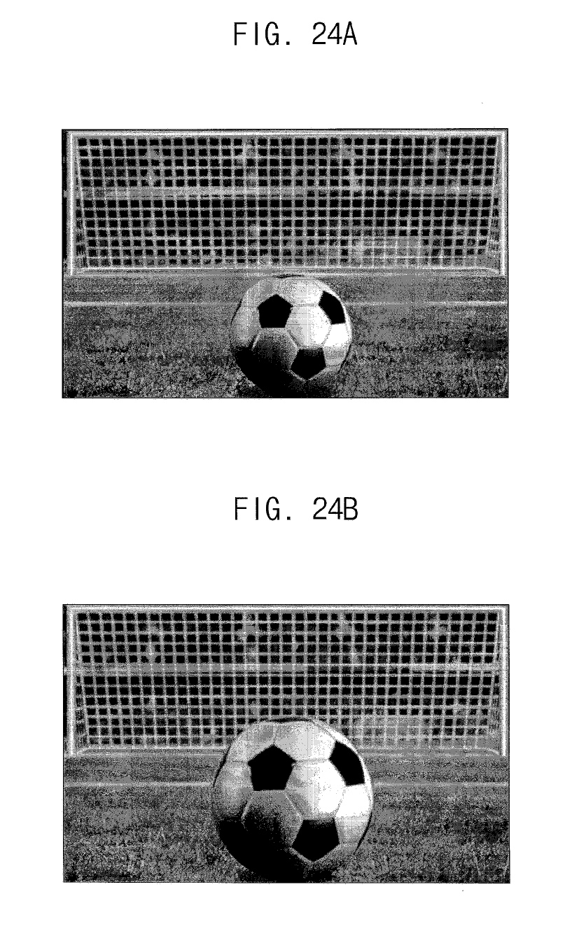

Referring now to FIG. 22, an input image may include an object (e.g., a soccer ball) and a background (e.g., a goalpost and surrounding soccer field, etc.). FIG. 23 shows a depth image of the input image in FIG. 22. As shown in FIG. 23, the depth image may include an object region (e.g., a relatively bright area) and a background region (e.g., a relatively dark area). FIG. 24A shows an example where the object and the background are up-scaled with the same scaling ratio. On the other hand, FIG. 24B shows an example where the object is up-scaled with a relatively large ratio and the background is up-scaled with a relatively small ratio. In other words, the up-scaling in FIG. 24B is performed using the disparate scaling approach as per the teachings of the present disclosure. From the comparison of FIGS. 24A and 24B, it is observed that the 3D perspective effect may be better represented when the object and the background images are up-scaled using different scaling ratios—as is the case in FIG. 24B.

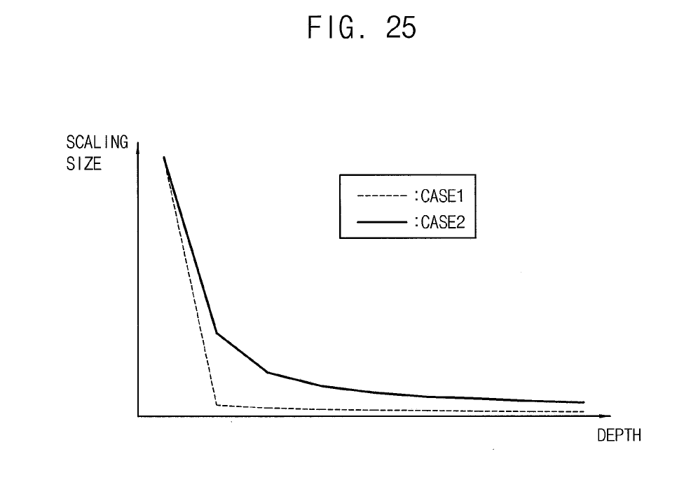

Referring now to FIG. 25, CASE1 is a graph (dotted line) that indicates an example where a scaling ratio is a first ratio, and CASE2 is a graph (straight line) that indicates an example where a scaling ratio is a second ratio greater than the first ratio. For example, the first ratio may be about 1, and the second ratio may be about 10.

In the graphs of FIG. 25, a relationship between a scaling size and a depth value may satisfy Equation 1 below:

SC=(a*SRC)/(DST*DP) [Equation 1]

In Equation 1, “SC” denotes the scaling size, “a” denotes the scaling ratio, “SRC” denotes an original size of the object, “DST” denotes a target size of the object, and “DP” denotes the depth value. It may be assumed that SC is about 1 if DP is about zero.

In comparison with the case where the scaling ratio is the first ratio (e.g., CASE1 in FIG. 25), the degree of up-scaling of the object recognized by the user may increase in the case where the scaling ratio is the second ratio (e.g., CASE2 in FIG. 25). Accordingly, when the object is up-scaled with a relatively large ratio and the background is up-scaled with a relatively small ratio, the object may be enlarged more than the background, and, hence, the 3D perspective effect may be efficiently represented in the final output image that combines the disparately enlarged versions of the object and the background portions of the input image.

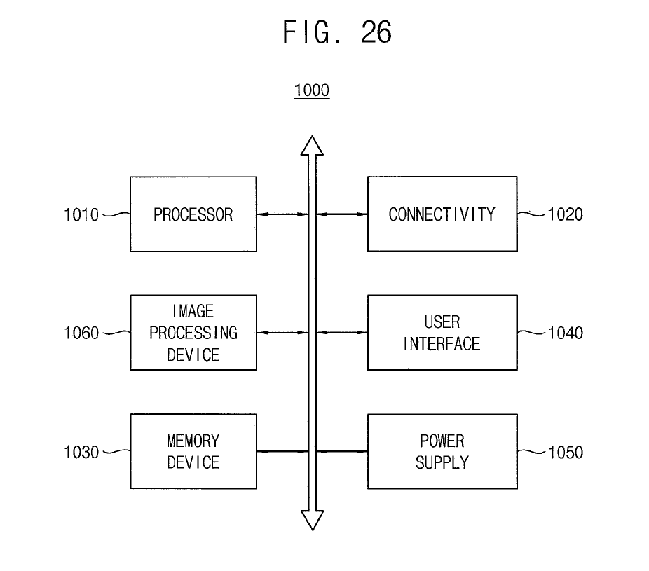

FIGS. 26, 27 and 28 are exemplary block diagrams illustrating an electronic system according to particular embodiments of the present disclosure.

Referring to FIG. 26, an electronic system 1000 may include a processor 1010 and an image processing device 1060. The electronic system 1000 may further include a connectivity module 1020, a memory device 1030, a user interface 1040, and a power supply 1050. Although not illustrated in FIG. 26, the electronic system 1000 may further include a graphic processor. The processor 1010 and the image processing device 1060 may be implemented on the same semiconductor substrate.

The processor 1010 may perform various computational functions such as, for example, particular calculations and task executions. For example, the processor 1010 may be a central processing unit (CPU), a microprocessor, an application processor (AP), etc. The processor 1010 may execute an operating system (OS) to drive the electronic system 1000, and may execute various applications for providing an internet browser, a game, a video, a camera, etc.

In some exemplary embodiments, the processor 1010 may include a single processor core or multiple processor cores. In certain embodiments, the processor 1010 may further include a cache memory (not shown) that may be located inside or outside the processor 1010.

The connectivity module 1020 may communicate with an external device (not shown). The connectivity module 1020 may communicate using one of various types of communication interfaces such as, for example, universal serial bus (USB), ethernet, near field communication (NFC), radio frequency identification (RFID), a mobile telecommunication like 4th generation (4G) and long term evolution (LTE), and a memory card interface. In particular embodiments, for example, the connectivity module 1020 may include a baseband chipset, and may support one or more of a number of different communication technologies such as, for example, global system for mobile communications (GSM), general packet radio service (GPRS), wideband code division multiple access (WCDMA), high speed packet access (HSPA), etc.

The memory device 1030 may operate as a data storage for data processed by the processor 1010 or a working memory (not shown) in the electronic system 1000. For example, the memory device 1030 may store a boot image for booting the electronic system 1000, a file system for the operating system to drive the electronic system 1000, a device driver for an external device connected to the electronic system 1000, and/or an application executed on the electronic system 1000. In particular embodiments, the memory device 1030 may include a volatile memory such as, for example, a DRAM, a SRAM, a mobile DRAM, a double data rate (DDR) synchronous DRAM (SDRAM), a low power DDR

(LPDDR) SDRAM, a graphic DDR (GDDR) SDRAM, or a Rambus DRAM (RDRAM), etc. and/or a non-volatile memory such as, for example, an EEPROM, a flash memory, a PRAM, an RRAM, an NFGM, a PoRAM, an MRAM, a FRAM, etc.

The user interface 1040 may include at least one input device such as, for example, a keypad, a button, a microphone, a touch screen, etc., and/or at least one output device such as, for example, a speaker, a display device, etc. The power supply 1050 may provide power to the electronic system 1000.

The image processing device 1060 may be operatively controlled by the processor 1010. The image processing device 1060 may be any one of the image processing devices shown in FIGS. 1, 13-15, and 17, and may operate according to the teachings of the present disclosure as explained with reference to the exemplary embodiments of FIGS. 1-21. For example, in the image processing device 1060, the scaling operation for generating a 3D scaled output image may be performed on different 2D portions of the input image with different, portion-specific scaling ratios. Furthermore, the scaled output image may be generated based on only the 2D scaling operation. Accordingly, the 3D perspective effect may be efficiently represented in the scaled output image in real time with a relatively small workload and low processing cost.

In some exemplary embodiments, at least a portion of the operations for generating the output image may be performed by instructions (e.g., a software program) that are executed by the image processing device 1060 and/or the processor 1010. These instructions may be stored in the memory device 1030. In other exemplary embodiments, at least a portion of the operations for generating the output image may be performed by hardware implemented in the image processing device 1060 and/or the processor 1010.

As noted before, in some exemplary embodiments, the electronic system 1000 may be any mobile system, such as, for example, a mobile phone, a smart phone, a tablet computer, a laptop computer, a VR or robotic system, a personal digital assistant (PDA), a portable multimedia player (PMP), a digital camera, a portable game console, a music player, a camcorder, a video player, a navigation system, etc. In particular embodiments, the mobile system may further include a wearable device, an internet of things (IoT) device, an internet of everything (IoE) device, an e-book, etc.

In another exemplary embodiments, the electronic system 1000 may be any computing system, such as, for example, a personal computer (PC), a server computer, a workstation, a tablet computer, a laptop computer, a mobile phone, a smart phone, a PDA, a PMP, a digital camera, a digital television, a set-top box, a music player, a portable game console, a navigation device, etc.

The electronic system 1000 and/or the components of the electronic system 1000 may be packaged in various forms, such as, for example, a package on package (PoP), a ball grid array (BGA), a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small outline IC (SOIC), a shrink small outline package (SSOP), a thin small outline package (TSOP), a system in package (SIP), a multi chip package (MCP), a wafer-level fabricated package (WFP), or a wafer-level processed stack package (WSP).

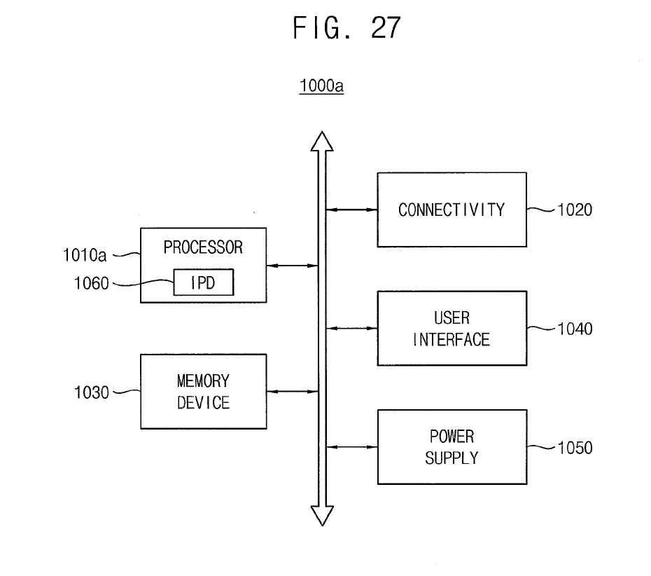

Referring now to FIG. 27, an electronic system 1000a may include a processor 1010a that implements the image processing device 1060 (which is shown as being implemented separately in the embodiment of FIG. 26). Like the embodiment in FIG. 26, the electronic system 1000a may further include the connectivity module 1020, the memory device 1030, the user interface 1040, and the power supply 1050. In other words, the electronic system 1000a of FIG. 27 may be substantially the same as the electronic system 1000 of FIG. 26, except that the image processing device 1060 is implemented as part of the processor 1010a in the embodiment of FIG. 27.

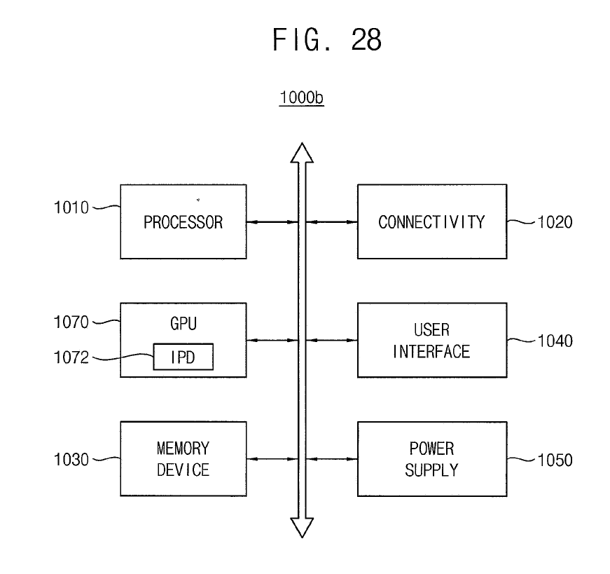

Referring to FIG. 28, an electronic system 1000b may include the processor 1010 (as also shown in the embodiment of FIG. 26), a graphic processor or graphic processing unit (GPU) 1070, and an image processing device (IPD) 1072. Like the embodiment in FIG. 26, the electronic system 1000b may also include the connectivity module 1020, the memory device 1030, the user interface 1040, and the power supply 1050. Overall, the electronic system 1000b of FIG. 28 may be substantially the same as the electronic system 1000 of FIG. 26, except that the electronic system in the embodiment of FIG. 28 further includes the graphic processor 1070 and that the image processing functionality—as represented by the image processing device 1072 in FIG. 28—is implemented through the graphic processor 1070.

In particular embodiments, the graphic processor 1070 may be separate from the processor 1010, and may perform at least one data processing associated with the image processing. For example, the data processing may include an image scaling operation (as discussed before), an image interpolation, a color correction, a white balance, a gamma correction, a color conversion, etc.

In the embodiment of FIG. 28, the image processing device 1072 may be operatively controlled by the processor 1010 and/or the graphic processor 1070. The image processing device 1072 may be any one of the image processing devices shown in FIGS. 1, 13-15, and 17, and may operate according to the teachings of the present disclosure as explained with reference to the exemplary embodiments of FIGS. 1-21. For example, in the image processing device 1072, the scaling operation for generating a 3D scaled output image may be performed on different 2D portions of the input image with different, portion-specific ratios. Furthermore, the scaled output image may be generated based on only the 2D scaling operation. Accordingly, the 3D perspective effect may be efficiently represented in the scaled output image in real time with a relatively small workload and low processing cost.

In some exemplary embodiments, the electronic system 1000 of FIG. 26, the electronic system 1000a of FIG. 27, and the electronic system 1000b of FIG. 28 each may further include an image pickup module (e.g., similar to the image pickup module 170 in FIG. 14 or the image pickup module 180 in FIG. 15) and/or a depth measurement module (e.g., similar to the depth measurement module 190 in FIG. 15).

As will be appreciated by those skilled in the art, the present disclosure may be implemented as a system, method, computer program product having compuer readable program code contained thereon, and/or a computer program product embodied in one or more computer readable medium(s). The computer readable program code may be provided to and executed by a processor of a general purpose computer, special purpose computer, or other programmable data processing apparatus. Upon execution, the computer readable program code may enable the processor to perform various image processing operations/tasks necessary to implement at least some of the teachings of the present disclosure. The computer readable medium may be a computer readable signal medium or a computer readable data storage medium. The computer readable data storage medium may be any tangible medium that can contain or store a computer program for use by or in connection with an instruction execution system, apparatus, or device. In particular embodiments, the computer readable medium may be a non-transitory computer readable medium.

The present disclosure may be used in any device or system that includes an image processing device. As noted before, such a system may be, for example, a mobile phone, a smart phone, a PDA, a PMP, a digital camera, a digital television, a set-top box, a music player, a portable game console, a navigation device, a PC, a server computer, a workstation, a tablet computer, a laptop computer, a smart card, a printer, etc.

The foregoing discussion is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present disclosure. Accordingly, all such modifications are intended to be included within the scope of the present disclosure as defined in the claims. Therefore, it is to be understood that the foregoing discussion is not to be construed as limited to the specific exemplary embodiments disclosed herein, and that modifications to the disclosed embodiments, as well as other additional exemplary embodiments, are intended to be included within the scope of the appended claims.

1. An image processing device comprising:
an image segmenter configured to generate a first two-dimensional (2D) image and a second 2D image by dividing an input image based on color information of the input image and depth information of the input image;
a scaler configured to generate a first conversion image by resizing the first 2D image based on a first scaling value and a second conversion image by resizing the second 2D image based on a second scaling value different from the first scaling value; and
a blender configured to generate an output image having a three-dimensional (3D) perspective effect by combining the first conversion image with the second conversion image.

2. The image processing device of claim 1, wherein the first conversion image is a magnified image of the first 2D image, and the second conversion image is a magnified image of the second 2D image, and
wherein the first scaling value is greater than the second scaling value.

3. The image processing device of claim 1, wherein the first 2D image is associated with a first object in the input image, and the second 2D image is associated with a second object in the input image different from the first object.

4. The image processing device of claim 3, wherein the output image is generated by superimposing the first conversion image onto the second conversion image.

5. The image processing device of claim 1, wherein the first 2D image is associated with a first object in the input image, and the 2D second image is associated with a second object in the input image different from the first object.

6. The image processing device of claim 1, wherein the image segmenter is configured to further generate a third 2D image by dividing the input image based on the color information of the input image and the depth information of the input image,
wherein the scaler is configured to further generate a third conversion image by resizing the third 2D image based on one of the following:
the first scaling value,
the second scaling value, and
a third scaling value different from the first and the second scaling values, and
wherein the blender is configured to generate the output image by combining the first, the second, and the third conversion images with one another.

7. The image processing device of claim 1, wherein the scaler includes:
a first scaling unit configured to generate first conversion image data corresponding to the first conversion image and first image data corresponding to the first 2D image; and
a second scaling unit configured to generate second conversion image data corresponding to the second conversion image and second image data corresponding to the second 2D image.

8. The image processing device of claim 1, wherein the scaler includes:
a first scaling unit configured to generate first conversion image data corresponding to the first conversion image based on the first scaling value and first image data corresponding to the first image, and further configured to generate second conversion image data corresponding to the second conversion image based on the second scaling value and second image data corresponding to the second image.

9. The image processing device of claim 8, wherein the scaler further includes:
a storage unit configured to store the first conversion image data and the second conversion image data.

10. The image processing device of claim 1, wherein the image segmenter includes:
a color segmentation unit configured to generate a plurality of color data by performing a color classification on the input image based on the color information of the input image; and
a clustering unit configured to generate first image data corresponding to the first 2D image and second image data corresponding to the second 2D image based on the plurality of color data and the depth information of the input image.

11. The image processing device of claim 10, wherein the clustering unit is configured to further determine the first scaling value and the second scaling value based on the depth information of the input image.

12. The image processing device of claim 1, further comprising:
a scaling value generator configured to determine the first scaling value and the second scaling value based at least on the depth information of the input image.

13-15. (canceled)

16. A method of image processing, the method comprising:
generating a first two-dimensional (2D) image and a second 2D image by dividing an input image based on color information of the input image and depth information of the input image;
generating a first conversion image by resizing the first 2D image based on a first scaling value;
generating a second conversion image by resizing the second 2D image based on a second scaling value different from the first scaling value; and
generating a three-dimensional (3D) output image by combining the first conversion image with the second conversion image.

17. The method of claim 16, further comprising:
determining the first scaling value and the second scaling value based at least on the depth information of the input image.

18. The method of claim 16, further comprising:
generating a third 2D image by dividing the input image based on the color information of the input image and the depth information of the input image; and
generating a third conversion image by resizing the third image based on one of the following:
the first scaling value,
the second scaling value, and
a third scaling value different from the first and the second scaling values, and wherein generating the 3D output image includes:
generating the 3D output image by combining the first, the second, and the third conversion images with one another.

19. The method of claim 16, wherein generating the 3D output image includes:
superimposing the first conversion image onto the second conversion image to create a 3D perspective effect.

20. An electronic system comprising:
a processor; and
an image processing device coupled to the processor, wherein the image processing device is operatively configured by the processor to perform the following:
generate a first two-dimensional (2D) image and a second 2D image by dividing an input image based on color information of the input image and depth information of the input image;
generate a first conversion image by resizing the first 2D image based on a first scaling value and further generate a second conversion image by resizing the second 2D image based on a second scaling value different from the first scaling value; and
generate an output image having a three-dimensional (3D) perspective effect by combining the first conversion image with the second conversion image.

21. (canceled)

22. The electronic system of claim 20, further comprising:
a graphic processor that is separate from the processor,
wherein the graphic processor is coupled to the processor and the image processing device is implemented in the graphic processor.

23. The electronic system of claim 20, further comprising:
an image pickup module coupled to the processor and the image processing device, wherein the image pickup module is operatively configured by the processor to obtain the color information of the input image and the depth information of the input image.

24. The electronic system of claim 20, further comprising:
an image pickup module coupled to the processor and the image processing device, wherein the image pickup module is operatively configured by the processor to obtain the color information of the input image; and
a depth measurement module coupled to the processor and the image processing device, wherein the depth measurement module is operatively configured by the processor to obtain the depth information of the input image.

25-31. (canceled)
